(19) United States
(12) Patent Application Publication
(10) Pub. No.: US 2025/0219715 A1
(43) Pub. Date: Jul. 3, 2025

(54) SELECTIVE SPECTRUM RECORDING METHOD FOR COLLECTING DATA BY SATELLITE

(71) Applicant: EUTELSAT SA, ISSY LES MOULINEAUX (FR)

(72) Inventors: Florian COLLARD, ISSY LES MOULINEAUX (FR); Matthieu THIEBAUT, ISSY LES MOULINEAUX (FR); Arnaud BARTHERE, ISSY LES MOULINEAUX (FR); Orazio PULVIRENTI, ISSY LES MOULINEAUX (FR); Daniele Vito FINOCCHIARO, ISSY LES MOULINEAUX (FR); Geoffroy BRICHLER, ISSY LES MOULINEAUX (FR)

(21) Appl. No.: 18/877,035

(22) PCT Filed: Jun. 23, 2022
(86) PCT No.: PCT/IB2022/000370

§ 371 Date: Dec. 19, 2024

(51) Int. Cl. H04B 7/185

(52) U.S. Cl. CPC H04B 7/18513

(57) ABSTRACT

A method for collecting at least one message received from at least one terminal, the method being performed on-board a satellite, includes receiving, continuously in time, a main signal over a main frequency band, sampling the received main signal, searching, in the samples of the main signal, a preamble signal emitted by the terminal, the preamble signal being included in a preamble frequency band, the preamble frequency band being included in the main frequency band, if a preamble signal has been found at the procedure of searching, storing data digital samples of at least one data signal in the memory of the satellite, the data signal being included within at least one data frequency band comprised in the main frequency band, the digital samples resulting from a sampling of the received signal within the data frequency band.

### TECHNICAL FIELD

The technical field of the invention is the field of satellite communications.

The present invention concerns a satellite-based method using a selective spectrum recording strategy to collect messages from terminals which are preferably ground-based. The selective spectrum recording strategy is carried out thanks to the sending of a preamble before the useful data.

### STATE OF THE ART

With the development of Internet of Things (“IoT”) networks, Low Earth Orbit (“LEO”) satellites constellations have been found to be of interest as they particularly well integrate with such systems. Indeed, LEO satellites allow a global coverage starting from just one satellite. LEO satellites constellations are for example used for data collection, to retrieve data from parts of IoT networks and to deliver the data to other parts of said networks.

Most of the time, these constellations are used to retrieve data from ground-based objects unable to communicate with the rest of the network due to their location, and to deliver said data to ground-based stations of the network to make the data accessible by the rest of the network. Constellations of Low Earth Orbit (LEO) satellites are thus subject to substantial developments as connecting remote users is becoming an important matter.

The objects emit messages to the LEO satellites when in radio visibility of a satellite; in the constellations targeted by this invention, the LEO satellites store all messages received, and later emit the messages to the ground-based stations when in radio visibility of a ground-based station. The LEO satellites constellations are therefore used as “store-and-forward” relays in the system comprising the constellation and an IoT network.

Two solutions are currently envisaged to collect by satellite messages emitted by objects located everywhere on the globe:
Recording the spectral band inside which objects transmit their messages, and transmitting this recording to a ground-based station when said station is in visibility of the satellite. The ground-based station then demodulates the received signal on the ground. An advantage of this solution is that the satellite does not have to comprise a demodulator, making its conception simpler. Also, the satellite has no knowledge of the protocols used by the objects and its conception is therefore not constrained by said protocols. However, the recording is very resources-intensive in terms of memory and of bandwidth use on the link to the ground, which constrains the satellite to limit the recording in frequency band and in time.
Demodulate onboard the satellite the signals transmitted by the objects and retransmit the content of said signals, that is the messages, to a ground-based station when said station is in visibility of the satellite. An advantage of this solution is that only the messages are stored inside the satellite, that is only the content of the signals and not entire spectral bands, with a limited resources consumption, that is with limited memory and limited bandwidth use on the link to the ground-based station. However, the satellite conception is far more complex than the first solution, as the satellite has to demodulate the signals and therefore to have knowledge of the different protocols used and the capacity to demodulate the signals following these different protocols. It is also complex for different messages modulated with different waveforms to cohabit inside the satellite. A used solution is to have a fixed protocol but the communication system if then less flexible.

There is therefore a need to be able to provide a satellite-based data collection method which overcomes the drawbacks of the state of the art.

### SUMMARY OF THE INVENTION

The present invention solves the above-mentioned problems by providing a method which can be carried out by a simple, flexible and cost-effective satellite communication payload.

According to a first aspect of the invention, this is satisfied by providing a method for collecting at least one data message sent by at least one terminal, said method being performed on-board a satellite, said satellite comprising a memory for storing data and means for processing data stored by said memory, and comprising at least the steps of:
receiving, continuously in time, a main signal over a predetermined main frequency band,
sampling at least part of the received main signal to obtain digital samples,
searching, in the digital samples of the received main signal, at least one preamble signal emitted by the at least one terminal, the at least one preamble signal being comprised in a predetermined preamble frequency band, the predetermined preamble frequency band being comprised in the predetermined main frequency band,
if a preamble signal has been found at the step of searching, storing data digital samples of at least one data signal in the memory of the satellite, the data digital samples representing the at least one data message, the at least one data signal being comprised within at least one predetermined data frequency band comprised in the predetermined main frequency band, the digital samples resulting from a sampling of the received signal within the data frequency band.

Thanks to the invention, it is possible to only store the relevant data, that is the received sampled signals corresponding to an actual message sent by a terminal. Contrary to the state of the art, this permits to both have a simple method to process the received signals, thus to have a simple satellite conception, and to gain memory storage onboard the satellite as well as bandwidth for the link from the satellite to the ground. The invention allows to improve the data collection scheme when choosing the strategy to record the spectrum on board the satellite, optimizing the amount of data to be stored on board and to be sent back to the ground stations.

It also allows the collection via satellite of modulated messages with different waveforms since the implementation on board the satellites is independent from the modulation.

The invention allows:
to transfer the demodulation of messages to the ground instead of having it on board the satellites, which allows
   to update more easily this ground-based demodulator, for example to add new functionalities to it;
   to improve demodulation performance through the implementation of more efficient demodulation techniques such as “Successive Interference Cancellation”, or simply adding new processing hardware when required;
to overcome the constraints faced by the state of the art linked to the absence of a demodulator on board the satellite in terms of the quantity of data that can be sent back to the ground,
the coexistence of distinct waveforms used by objects served by the same satellite.

The method of the invention may also have one or more of the following characteristics, considered individually or according to any technically possible combinations thereof:
the method further comprises, if no preamble signal has been found at the step of searching at least one preamble, at least the step of deleting the stored main signal from the memory of the satellite.
the method further comprises the steps of:
   counting the number of preamble signals found,
   estimating the load of the data channel based on the number of preamble signals found, and
   modifying the width of the data frequency band or adding new frequency channels to adapt to the load.
the preamble signal comprises at least one piece of information related to the at least one data signal emitted from the at least one terminal, wherein the data digital samples result from a sampling of the received signal within the data frequency band, the sampling being based on the at least one piece of information, and wherein the information related to the at least one data signal from the at least one terminal being at least one of:
   a duration of the data message comprised in the data signal,
   a frequency slot of the data signal,
   a time relationship and/or a frequency relationship between the preamble signal and the data signal,
   the central frequency and bandwidth of the data frequency band if the data frequency band is not predetermined
   the modulation protocol used for the data message.
the sampling of the main signal is performed within the at least one predetermined preamble frequency band.
the sampling of the main signal is performed on the whole predetermined main frequency band,
the samples resulting from the sampling of the main signal within the whole predetermined radio bandwidth are stored in the memory of the satellite and
the step of searching the at least one preamble signal is performed on the stored samples of the main signal.
after having found the at least one preamble signal, the sampling of the main signal within the data frequency band to obtain the message samples stored in the memory of the satellite comprises, if the data frequency band is smaller than the predetermined main frequency band, resampling (via digital signal processing) the samples of the main signal stored in the memory of the satellite to keep in the memory of the satellite the samples corresponding to the at least one data signal comprising the at least one message.
the method comprises, before the step of receiving the main signal, a step of emitting at least one beacon signal periodically towards the Earth, the beacon signal comprising at least one piece of information about the at least one predetermined preamble frequency band and/or about the at least one data frequency band and/or a parameter to statistically delay or inhibit emissions from terminals.
the at least one piece of information comprised in the beacon signal is determined based on a measurement, by the satellite, of a noise level over the whole predetermined main frequency band.
the method comprises, after the step of storing the data samples and when the satellite is in the range of a ground station, a step of transmitting to said ground station the data samples stored in the memory, wherein at least one additional piece of information related to the data samples is transmitted along with its corresponding data samples, the data samples forming at least one data message and the additional piece of information being at least one of:
   waveform of the data message,
   information derived from the preamble related to the data message,
   estimated Doppler shift and Doppler rate information on the preamble found,
   time and/or frequency of the data samples,
   satellite position and/or speed when receiving the data message and/or when transmitting the data samples to the ground station,
   geographic region within which the data signal was emitted,
   antenna of the satellite within which the data signal was received,
   information comprised in the beacon signal.

Another aspect of the invention relates to a method of transmission of a message between at least one terminal and at least one ground-based station, the method comprising at least the steps of:
Sending, by a terminal, at least one preamble signal in a predetermined preamble frequency band,
Sending, by the terminal, at least one data signal in a data frequency band,
Collecting and forwarding to the ground-based station, by a satellite, the at least one message using the method according to the invention,
Receiving, by the at least one ground-based station, the data samples,
Demodulating, by the at least one ground-based station or other device connected to it, the data samples using at least one demodulation module.

This method of transmission can further comprise the following feature: the message samples comprise a plurality of messages, the plurality of messages comprising at least a first and a second message modulated differently, the step of demodulating comprising demodulating at least part of the message samples corresponding to the first message using the at least one demodulation module and demodulating at least another part of the message samples corresponding to the second message using at least one other demodulation module.

Another aspect of the invention relates to a computer program product comprising instructions which, when the program is executed by a computer, causes the computer to carry out the method according to the invention.

Another aspect of the invention relates to a computer-readable medium comprising instructions which, when executed by a computer, cause the computer to carry out the method according to the invention.

### BRIEF DESCRIPTION OF THE FIGURES

Other characteristics and advantages of the invention will become clear from the description that is given thereof below, by way of indication and in no way limiting, with reference to the appended figures, among which:

FIG. 1 shows a schematic representation of a system to carry out the method of the invention.

FIG. 2 shows a schematic representation of a first embodiment of the invention.

FIG. 3 shows a schematic representation of a second embodiment of the invention.

### DETAILED DESCRIPTION

For greater clarity, identical or similar elements are marked by identical reference signs in all of the figures.

The invention is a method for collecting, by a satellite, data sent by an object. The data is comprised in a data signal and a preamble signal permits to let the satellite know that a data signal is to follow. The invention has several embodiments, which encompass different ways of sampling and of storing the samples resulting thereof.

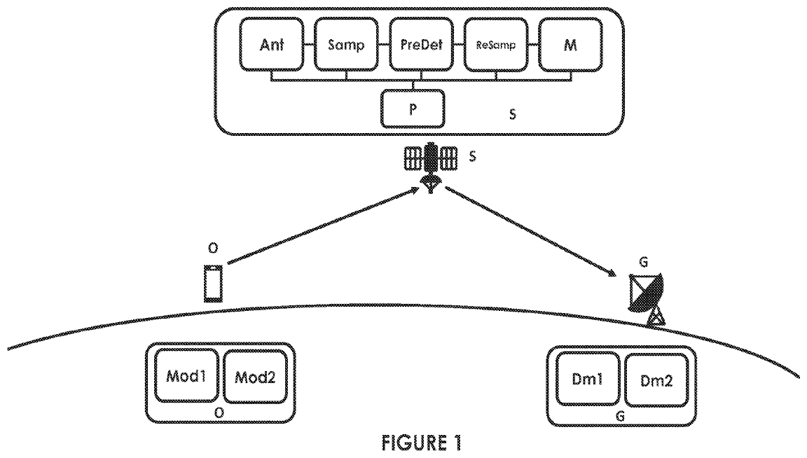

FIG. 1 shows a schematic representation of a system to implement the collecting method according to the invention.

In the system represented at FIG. 1, a satellite S collects data from an object O and later transmits said collected data to a ground-based station G. FIG. 1 shows the two transmissions at the same time for the sake of simplicity only, as the data is transmitted from the satellite S to the ground-based station S after having received data from the object O and only when the ground-based station G is in visibility of the satellite S, so that data is stored onboard the satellite S for a period of time. The object O can be any object able to send data towards space, such as a resources-constrained object belonging to an Internet of Things network, a mobile device such as a mobile phone, or any other object able to send signals modulated according to at least one predetermined waveform towards space and in particular to reach the satellite S. The ground-based station G of the invention is able to demodulate the signals sent by the objects as will be explained later. The actual demodulation can occur on another device or even on processing hardware physically distant from the gateway, for example operated as a service by a third party. The satellite S is preferably a Low-Earth Orbit (LEO) satellite as the invention applies particularly well to such type of satellites, but the satellite S can be any other type of satellite to carry out the invention.

The satellite S comprises at least one memory and at least one processor, the memory storing instructions which, when executed by the processor, cause the processor to carry out the method according to the invention. When an action is said to be carried out by the satellite S, it is in fact carried out by said processor of the satellite S.

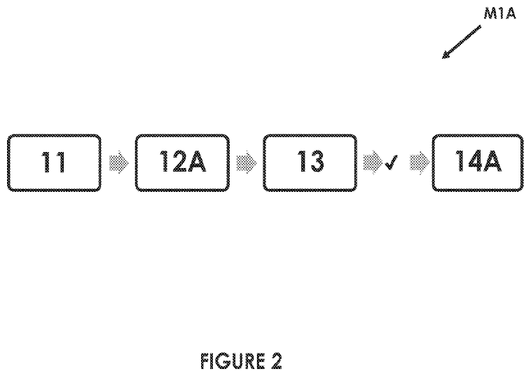

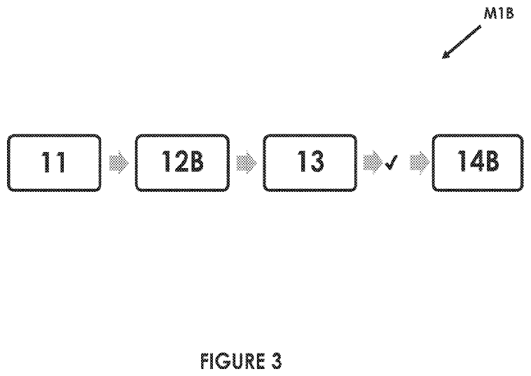

FIG. 2 shows a schematic representation of a first embodiment of a method for collecting data according to the invention. FIG. 3 shows a schematic representation of a second embodiment of a method for collecting data according to the invention.

The method M1A represented at FIG. 2 comprises four steps. The method M1A of FIG. 2 is carried out by the satellite S and permits to collect data in the form of messages, the messages having been sent by the object O.

The method M1B represented at FIG. 3 comprises four steps. The method M1B of FIG. 3 is carried out by the satellite S and permits to collect data in the form of messages, the messages having been sent by the object O.

The first step of the method M1A and the first step of the method M1B are the same step, that is a step 11 of receiving a main signal over a predetermined main frequency band. The receiving of a signal over a predetermined main frequency band can and will also be called recording a “spectral band” or recording a “spectrum”. This receiving comprises producing a filtered signal using an antenna, a low-noise amplifier and a filter at the input of a sampler Samp. The received signal can be temporary stored for processing, for example in the memory M of the satellite S, or can be directly transmitted to a next module of the satellite S which will perform another step of the method M1A on said recording. The predetermined main frequency band preferably covers several frequency bands used by different objects O, and can be for example comprised in a configuration of the satellite S. The predetermined main frequency band is the frequency band that is studied to find both preamble signals and data signals as it can comprise both types of signals. This main band thus comprises the preamble frequency band and the data frequency band. The main band can comprise several preamble frequency bands and several data frequency bands, or any possible combination of predetermined frequency bands, that is for example one preamble band and several data bands or several preamble bands and one data band. All the preamble frequency bands of the invention are predetermined, that is they are determined before step 11, by being stored in the memory of the satellite S as one or several configurations of the satellite S, or by being determined dynamically by the satellite S as will be explained later. An example of a preamble frequency band is for example a width of 20 KHz and a center frequency of 868.3 MHz and an example of a data frequency band is a width of 150 kHz and a center frequency of 868.1 MHz. Two data frequency bands can be used with one preamble frequency band, for example by adding another data frequency band with a width of 250 KHz and a center frequency of 868.2 MHz.

The receiving is performed “continuously in time” meaning that this step is performed non-stop during a predetermined time window. The other steps of the methods M1A and M1B can then be performed in a parallel way to the first step 11, that is during the continuous receiving. For the predetermined time window, for example several hours, days, months or years, the other steps of the methods M1A and M1B can be performed several times each while the satellite keeps recording the main signal.

The method M1A comprises a second step 12A of sampling of the recorded main signal to obtain digital samples. The sampling, in the first embodiment, that is in the method M1A, is performed on the whole predetermined main frequency band of the recorded main signal sent by the object O.

Step 12A is comprised in an embodiment where the sampling is performed on the whole predetermined main frequency band.

Step 12B is comprised in another embodiment represented at FIG. 3 where the sampling is performed on a predetermined preamble frequency band. This permits to reduce the recording to a narrower frequency band as compared to the first embodiment. A preamble frequency band is a frequency band which comprises preamble signals sent by the object O. When several preamble frequency bands are predetermined, the several frequency bands are sampled. A preamble frequency band is for example in the order of 5 to 30 KHz.

It is to be noted that, at step 12A, the preamble frequency band is also sampled as the whole predetermined main frequency band is sampled, the main frequency band comprising the preamble frequency band and the data frequency band.

The sampling of all the embodiments of the invention can be performed by a sampler Samp of the satellite S as represented at FIG. 1. The sampling permits to perform the following step 13.

The method M1 comprises the step 13 of searching for at least one preamble signal, the step 13 being comprised in both the embodiments M1A and M1B. This search is carried out by the preamble detector PreDet of the satellite S as represented at FIG. 1. This search can instead be carried out by the processor P. The search is performed among the digital samples of the recorded main signal resulting from the sampling of the step 12A or 12B. At least one preamble signal emitted by the object O can be found when a threshold is met or exceeded. Preamble detection can be for example carried out using cross-correlation in time domain or Fast Fourier Transform for each symbol time. For both methods, series of computed values are obtained. Each value is compared to a threshold value. If this value is superior to the threshold, a preamble is detected. The at least one preamble signal is comprised in the predetermined preamble frequency band, the predetermined preamble frequency band being comprised in the predetermined main frequency band. In the first embodiment, that is in the embodiment M1A comprising the step 12A, a step of selecting a subset of the samples (not represented) has to be performed, as only the samples corresponding to the preamble frequency band are used for the search.

The preamble signal can be a signal whose sole presence permits to indicate that a data signal is to follow or can be a signal carrying at least one piece of information.

In the first case, the sole presence of a signal in a predetermined preamble frequency band is linked by the satellite to the presence of a data signal in a data frequency band. In that case, the data band and the preamble band are linked for example in a table stored by the satellite S so that the satellite S knows in which data frequency band the object O will emit a data signal.

In the second case, that is when the preamble signal comprises at least one piece of information, the piece of information is related to the data signal and can be at least one of the following:
a duration of a message comprised in the data signal,
a frequency slot of the data signal,
a time relationship and/or a frequency relationship between the preamble signal and the data signal,
the central frequency and bandwidth of the data frequency band if the data frequency band is not predetermined,
the modulation protocol used for the message.

The invention covers any other piece of information related to the data signal that can be transmitted by the preamble signal.

Preferably, the at least one piece of information comprised in the preamble signal is encoded, that is the received piece of information represents an index among predetermined choices, the predetermined choices being comprised in the satellite S for example by configuration. An example of an encoded piece of information when the piece of information is a duration of a message comprised in the data signal follows:
‘00’ represents a message duration of less than 60 ms,
‘01’ represents a message duration of less than 120 ms
‘10’ represents a message duration of less than 180 ms
. . .

When the piece of information is not related to the data frequency band, that is when the satellite S can not determine the data frequency band from the piece of information comprised in the preamble signal, the data band and the preamble band are linked for example in a table stored by the satellite S so that the satellite S knows in which data frequency band the object O will emit a data signal.

Both methods M1A and M1B of the invention then comprise a step performed only if a preamble signal has been found at step 13.

If a preamble signal has been found at the step of searching, the method M1A comprises a step 14A of removing the unnecessary samples, that is the samples which are not related to a data signal. The data signal is sent by the object O and is comprised within at least one data frequency band comprised in the predetermined main frequency band. In this embodiment M1A, where the sampling was carried out at step 12A on the whole predetermined main frequency band, samples of the data signal already exist in the memory M of the satellite S. The digital samples of the data signal thus result from a sampling of the recorded signal within the data frequency band. The removing of the unnecessary samples, which are the samples not related to the data samples and/or the samples which are not deemed necessary for example by configuration, can comprise a resampling or equivalent digital signal processing. The resampling can be necessary if the ratio between the kept data frequency band and the already sampled main frequency band is not an integer. In such a case, the resampling is performed by the resampler Resamp of FIG. 1. If this ratio is an integer, the resampling results in only the unnecessary samples being deleted from the memory M of the satellite S. This permits for the method M1A to perform a storing of only the data samples in the memory M of the satellite S, thus saving storage.

In the embodiment of method M1B, the data has not yet been received nor sampled, as only the preamble frequency band has been received and sampled. The step 14B of storing the data samples thus comprises a sub-step, or the method M1B comprises a previous step, of sampling the received main signal only on the data frequency band. This can be done for example by the processor which, after detecting the preamble, could instruct the sampler Samp to enlarge the sampled band from the moment of detecting for a predetermined period of time. The sampling is performed by the sampler Samp of the satellite S. The data frequency band can be determined as explained previously, that is by configuration of the satellite S, in a table stored by the satellite S, or in at least one piece of information comprised in the preamble signal. The data samples are then stored in the memory M of the satellite S.

In both embodiments of the invention MIA and M1B, all the samples resulting from all the samplings of the methods are deleted from the memory M of the satellite S if no preamble signal has been found at the step 13 of searching for a preamble signal. Both embodiments M14A and M14B can use the information that could be embedded in the preamble, e.g. to select which frequency band to store or the duration of the signal that shall be stored in the memory.

Several variants of the invention will now be described. Some of these variants apply only to the embodiment of the method M1A, only to the embodiment of the method M1B, or to all embodiments of the invention, as will be detailed later.

In both embodiments M1A and M2A, the method can comprise, before the step 11 of receiving the main signal, a step carried out by the satellite S of emitting at least one beacon signal periodically towards the celestial body where the object O is located, the beacon signal comprising at least one piece of information about the at least one predetermined preamble frequency band and/or about the at least one data frequency band and/or a parameter to statistically delay or inhibit emissions from the object O. This beacon signal permits to set dynamically a preamble frequency band, a data frequency band or any other needed parameter for the transmission of messages from the object O to the ground-based station G.

In this variant comprising a beacon signal, an optional feature is that the at least one piece of information comprised in the beacon signal is determined based on a measurement, by the satellite S, of a noise level over the whole predetermined main frequency band. This permits to have a more reliable transmission of messages, that adapts to the environment of the satellite S and/or of the object O.

In another variant compatible with the previous variant and embodiments described, the sampling of the main signal within the data frequency band is based on a measured load of a data channel carrying the at least one message within the data frequency band. After the step 12 of searching for at least one preamble signal and after finding at least one preamble signal, this variant comprises the steps of:
counting the number of preamble signals found,
estimating the load of the data channel based on the number of preamble signals found, and
modifying the width of the data frequency band, either immediately or as a configuration change for future satellites covering the same region, or adding new frequency channels to adapt to the load.

These steps are all carried out by the satellite S. The step of modifying the width of the data frequency band can for example be carried out using the beacon signal presented previously. If the load of the data channel is deemed, by the satellite S, to be too high, the satellite S can instead send, in the beacon signal, a congestion flag, the congestion flag being a parameter to statistically delay or inhibit emissions from the object O.

The invention can further comprise, in any embodiment and/or any variant, when the satellite is in the range of the ground station G, a step of transmitting to said ground station G the data samples stored in the memory M of the satellite S, wherein at least one additional piece of information related to the data samples is transmitted along with its corresponding data samples. The data samples form at least one data message and the additional piece of information can be at least one of:
waveform of the data message,
information derived from the preamble related to the data message,
estimated Doppler shift and Doppler rate information on the preamble found,
time and/or frequency of the data samples,
satellite S position and/or speed when receiving the data message and/or when transmitting the data samples to the ground station G,
geographic region within which the data signal was emitted,
antenna of the satellite S within which the data signal was received,
information comprised in the beacon signal.

This permits to transmit efficiently to the ground-based station all the data messages stored by the satellite S, and for the ground station G to differentiate the different data messages received and to obtain more information about said data messages received. Indeed, the different stored data messages can come from different objects O, or from the same object O at different times and/or locations or any combination thereof.

The invention further covers a non-represented method of transmission of a message between the object O and the ground-based station G, the method comprising at least the steps of:
Sending, by the object O, at least one preamble signal in the predetermined preamble frequency band, wherein the preamble frequency band can be predetermined by configuration or can be based on the received piece of information comprised in the beacon signal according to the variant described previously,
Sending, by the object O, at least one data signal in the data frequency band, wherein the data frequency band can be predetermined by configuration or can be based on the received piece of information comprised in the beacon signal according to the variant described previously,
Collecting and forwarding to the ground-based station G, by the satellite S, the at least one message using the method of the invention according to any one of the embodiments and variants described previously,
Receiving, by the ground-based station G, the data samples,
Demodulating, by the ground-based station G or by a processing device connected to it, the data samples using at least one demodulation module Dm1 or Dm2.

In a variant of said method of transmission of a message between the object O and the ground-based station G wherein the data samples comprise a plurality of data messages, and wherein the plurality of data messages comprises at least a first and a second data message modulated differently, the step of demodulating comprises demodulating at least part of the data samples corresponding to the first data message using the at least one demodulation module, for example demodulator Dm1 and demodulating at least another part of the data samples corresponding to the second data message using at least one other demodulation module, for example Dm2. The demodulation module may be chosen by the ground-based station G based on the received piece of information related to the data messages sent by the satellite S with the data message, the piece of information indicating or comprising for example the waveform of the data message, for example by being indicated in the preamble signal received by the satellite S and linked to the data signal, or for example by being figured out by the satellite S based on the preamble signal received, for example using a table stored in its memory M. In another variant, all the samples are sent to both demodulators Dm1 and Dm2, and each demodulator will demodulate only the message using the corresponding modulation protocol.

The invention can be applied by any satellite S, receiving data from any object O sending data towards the satellite S for the data to be transmitted to a ground-based station G, and in particular by Low Earth Orbit satellites receiving data from a plurality of ground-based objects located at different location around the Earth.

1. A method for collecting at least one data message sent by at least one terminal, said method being performed on-board a satellite, said satellite comprising a memory for storing data and means for processing data stored by said memory, and comprising at least the steps of:
receiving, continuously in time, a main signal over a predetermined main frequency band,
sampling at least part of the received main signal to obtain digital samples,
searching, in the digital samples of the received main signal, at least one preamble signal emitted by the at least one terminal, the at least one preamble signal being comprised in a predetermined preamble frequency band, the predetermined preamble frequency band being comprised in the predetermined main frequency band,
if a preamble signal has been found at the step of searching, storing data digital samples of at least one data signal in the memory of the satellite, the data digital samples representing the at least one data message, the at least one data signal being comprised within at least one predetermined data frequency band comprised in the predetermined main frequency band, the digital samples resulting from a sampling of the received signal within the data frequency band.

2. The method for collecting at least one message according to claim 1, further comprises, if no preamble signal has been found at the step of searching at least one preamble, at least the step of deleting the stored main signal from the memory of the satellite.

3. The method for collecting at least one message according to claim 1, further comprising the steps of:
counting the number of preamble signals found,
estimating the load of the data channel based on the number of preamble signals found, and
modifying the width of the data frequency band.

4. The method for collecting at least one message according to claim 1, wherein the preamble signal comprises at least one piece of information related to the at least one data signal emitted from the at least one terminal, wherein the data digital samples result from a sampling of the received signal within the data frequency band, the sampling being based on the at least one piece of information, and wherein the information related to the at least one data signal from the at least one terminal being at least one of:
a duration of the message comprised in the data signal,
a frequency slot of the data signal,
a time relationship and/or a frequency relationship between the preamble signal and the data signal,
the central frequency and bandwidth of the data frequency band if the data frequency band is not predetermined,
the modulation protocol used for the message.

5. The method for collecting at least one message according to claim 1, wherein the sampling of the main signal is performed within the at least one predetermined preamble frequency band.

6. The method for collecting at least one message according to claim 1, wherein:
the sampling of the main signal is performed on the whole predetermined main frequency band,
the samples resulting from the sampling of the main signal within the whole predetermined radio bandwidth are stored in the memory of the satellite and
the step of searching the at least one preamble signal is performed on the stored samples of the main signal. cm 7. The method for collecting at least one message according to claim 6, wherein, after having found the at least one preamble signal, the sampling of the main signal within the data frequency band to obtain the message samples stored in the memory of the satellite comprises, if a ratio between the data frequency band and the predetermined main frequency band is an integer, resampling the samples of the main signal stored in the memory of the satellite to keep in the memory of the satellite the samples of the main signal corresponding to the at least one data signal comprising the at least one message.

8. The method for collecting at least one message according to claim 1, further comprising, before the step of receiving the main signal, a step of emitting at least one beacon signal periodically towards the Earth, the beacon signal comprising at least one piece of information about the at least one predetermined preamble frequency band and/or about the at least one data frequency band and/or a parameter to statistically delay or inhibit emissions from terminals.

9. The method for collecting at least one message according to claim 8, wherein the at least one piece of information comprised in the beacon signal is determined based on a measurement, by the satellite, of a noise level over the whole predetermined main frequency band.

10. The method for collecting at least one message according to claim 1, further comprising, after the step of storing the data samples and when the satellite is in the range of a ground station, a step of transmitting to said ground station the data samples stored in the memory, wherein at least one additional piece of information related to the data samples is transmitted along with its corresponding data samples, the data samples forming at least one data message and the additional piece of information being at least one of:
waveform of the data message,
information derived from the preamble related to the data message,
estimated Doppler shift and Doppler rate information on the preamble found,
time and/or frequency of the data samples,
satellite position and/or speed when receiving the data message and/or when transmitting the data samples to the ground station,
geographic region within which the data signal was emitted,
antenna of the satellite within which the data signal was received,
information comprised in the beacon signal.

11. A method of transmission of a message between at least one terminal and at least one ground-based station, the method comprising at least the steps of:
sending, by a terminal, at least one preamble signal in a predetermined preamble frequency band,
sending, by the terminal, at least one data signal in a data frequency band,
collecting and forwarding to the ground-based station, by a satellite, the at least one message using the method according to claim 10,
receiving, by the at least one ground-based station, the data samples,
demodulating, by the at least one ground-based station, the data samples using at least one demodulation module.

12. The method according to claim 11, wherein the message samples comprise a plurality of messages, the plurality of messages comprising at least a first and a second message modulated differently, the step of demodulating comprising demodulating at least part of the message samples corresponding to the first message using the at least one demodulation module and demodulating at least another part of the message samples corresponding to the second message using at least one other demodulation module.

13. A computer program product comprising instructions which, when the program is executed by a computer, causes the computer to carry out the method according to claim 1.

14. A non-transitory computer-readable medium comprising instructions which, when executed by a computer, cause the computer to carry out the method according to claim 1.
